(19) United States
(12) Patent Application Publication
(10) Pub. No.: US 2009/0079665 A1
(43) Pub. Date: Mar. 26, 2009

(54) Power and Video Unit for a Multi-Screen Display System

(76) Inventor: Jerry Moscovitch, Toronto (CA)

Correspondence Address: MASS ENGINEERED DESIGN INC., 474 WELLINGTON STREET WEST, TORONTO, ON, M5V-1E3, CA

(21) Appl. No.: 12/282,991

(22) PCT Filed: Mar. 14, 2007
(86) PCT No.: PCT/CA2007/000413

§ 371 Date: Sep. 15, 2008

Related U.S. Application Data
(60) Provisional application No. 60/767,250, filed on Mar. 14, 2006.
(60) Provisional application No. 60/796,975, filed on May 3, 2006.

(51) Int. Cl. G09G 5/00

(52) U.S. Cl. 345/1.3

(57) ABSTRACT

A power and video unit for use in a multi-screen display system is described herein. The unit includes a splitter that inputs a video signal from a laptop or desktop computer and converts the signal to a plurality of signals suitable for a multi-screen display system. The unit also includes a power assembly to power the multi-screen display system. The unit can be mounted to a column, base or other part of the multi-screen display system, or a stand-alone unit.

### FIELD OF THE INVENTION

The invention relates to multi-screen display systems, and more particularly to the delivery of power and video signals thereto.

### BACKGROUND OF THE INVENTION

Multi-screen display systems have become commonplace. By providing more display area than traditional computer systems having one screen, multi-screen display systems increase efficiency and reduce errors by limiting the number of times application windows have to be minimized and maximized during computer use.

With multi-screen display systems, however, the problem of cable management has become more pressing. Each monitor typically requires signals from a power cable and a video cable. In addition, the desktop or notebook computer controlling the monitors requires its own power cable. When peripheral devices are added, a tangle of cables can result.

In addition, when upgrading a single-screen computer system to a multi-screen display system, it is often necessary to add graphics ports to the computer system by removing part of the computer housing to replace or add graphics cards. This addition or replacement of graphics cards can be time-consuming, and expensive if a computer technician is paid to effect the changes.

Thus, any system that can improve cable management and make it easier to upgrade a single-screen system to a multi-screen display system would be most welcome.

### SUMMARY OF THE INVENTION

To address these shortcomings in the art, described herein is a power and video unit for a display system having N>1 screens, a base, an arm for supporting the N screens and a column for connecting the base to the arm. The power and video unit includes an image splitting device that takes as input M video signals from a computer and outputs N>M video signals, one for each of the N screens. The power and video unit also includes a power assembly for supplying power to each of the N screens.

The power and video unit can be disposed in or on any appropriate part of the multi-screen system, such as the base, the column, the arm or the screens. Instead, the power and video unit can reside in a housing as a stand-alone unit.

### BRIEF DESCRIPTION OF THE DRAWINGS

FIG. 1A shows a front view of a power and video unit for a multi-screen display system, according to the principles of the present invention.

FIG. 1B shows a back view of the power and video unit of FIG. 1A.

FIG. 2A shows a cross sectional view of a different embodiment of a power and video unit having a hinge, according to the principles of the present invention.

FIG. 2B shows a cross sectional view of the power and video unit of FIG. 2B with the hinge in an open position.

FIG. 2C shows a back view of the power and video unit of FIGS. 2A and 2B.

FIG. 3A shows a base mounted power and video unit connected to a base of a multi-screen display system, according to the principles of the present invention.

FIG. 3B shows the base mounted power and video unit of FIG. 3A unconnected to the base.

FIG. 3C shows perspective and exploded views of a base port deck of the base of the multi-screen display system that is connectable to the power and video unit of FIGS. 3A and 3B.

FIG. 3D shows perspective and exploded views of a unit connector deck of the power and video unit of FIGS. 3A and 3B.

FIG. 4 shows the power and video unit of FIGS. 3A and 3B connected to a notebook computer.

FIG. 5A shows another embodiment of a power and video unit connected coupled via cables to monitors of a multi-screen display system, consistent with the principles of the present invention.

FIG. 5B shows the power and video unit of FIG. 5A uncoupled from the monitors.

FIG. 6 shows another embodiment of a power and video unit integrated into a base of a multi-screen display system, in accordance with the principles of the present invention.

### DETAILED DESCRIPTION OF THE PREFERRED EMBODIMENTS

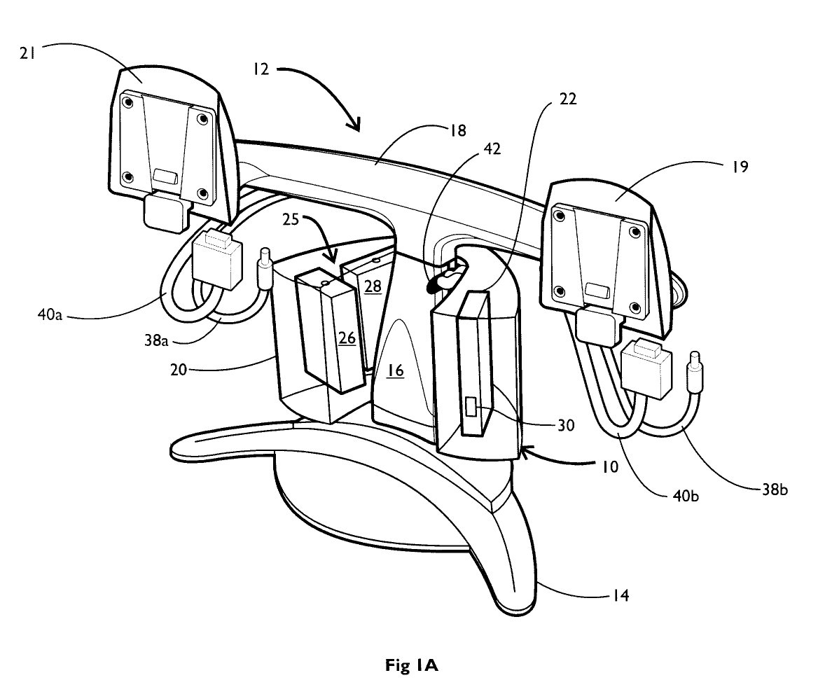

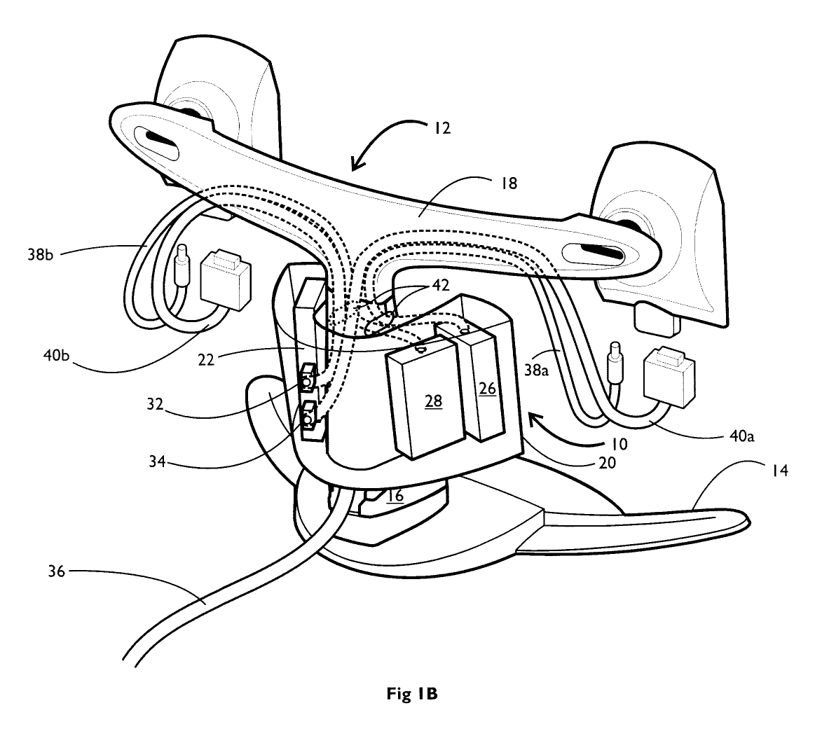

FIGS. 1A and 1B show a front view and a back view of a power and video unit 10 for a multi-screen display system 12. The multi-screen display system 12 includes a base 14, a column 16, and an arm 18. The arm 18 supports a plurality of display monitors with monitor connectors 19 and 21, such as the monitor connectors described in U.S. Pat. No. 6,702,604 by Moscovitch. In the embodiment shown in FIGS. 1A and 1B, the arm 18 supports two display monitors (not shown).

The power and video unit 10 includes a housing 20, an image splitting device 22 and a power assembly 25 having a plurality of power modules 26 and 28. The image splitting device 22 and the plurality of power modules 26 and 28 are contained in the housing 20, which partially wraps around the column 16 at the back thereof.

The splitting device 22 accepts a single video input signal via a video input port 30 from a laptop or desktop computer (not shown). The splitting device 22 processes the video input signal and outputs a plurality of output video signals via the output ports 32 and 34. One example of a commercially available splitting device is the DualHead2Go™ by Matrox Electronics Systems, Incorporated of Montreal, Canada. In one embodiment, there are as many video output ports (and output signals) as there are display monitors supported by the arm 18. Thus, in FIG. 1B, two output ports 32 and 34 are shown for feeding two display monitors that are supported by the arm 18.

The plurality of power modules 26 and 28 power the plurality of display monitors supported on the arm 18. In one embodiment, there are as many power modules as there are display monitors supported by the arm 18. Thus, in FIGS. 1A and 1B, two power modules 26 and 28 of the power assembly 25 are shown to provide power to two display monitors that are supported by the arm 18. However, it should be understood that, unlike the power modules 26 and 28 shown in FIGS. 1A and 1B that reside in separate housings, the power assembly could have one housing into which the power modules are integrated. In addition to sharing one housing, it should also be understood that the power modules could share other components. However many components of the power modules are integrated, two power cables, similar to power cables 38a and 38b, would feed the respective two screens of the multi-screen display system.

One external, integrated power/video cable 36 is connected to the power and video unit 10. With the use of a power divider (not shown), power can be divided and provided to the splitting device 22 and the power modules 26 and 28. Alternatively, two cables (instead of the one integrated power/video cable 36 shown) can be incorporated. In this case, one cable is a video cable from the laptop or desktop computer. The other cable is a power cable connected to an appropriate power source.

Output power cables 38a, 38b are coupled to the power modules 26 and 28, and output video cables 40a, 40b are coupled to the video output ports 32 and 34. These cables 38a, 38b, 40a and 40b enter the column 16 through apertures 42 therein, and run up the column 16 and across both sides of the arm 18. The cables 38a, 38b, 40a and 40b couple to the monitor connectors 19 and 21, which support and provide power and video signals to the two monitors. (In FIG. 1B, dashed lines are shown to represent the cables 38a, 38b, 40a and 40b inside the column 16 and arm 18. In FIG. 1A, the dashed lines are omitted for clarity.) Thus, power and video cables 38a and 40a feed one monitor, and power and video cables 38b and 40b feed a second monitor.

The power and video unit 10 is mounted on the column 16 of the multi-screen display system 10 using any one of various mounting means, such as screws or rivets (not shown). Alternatively, the power and video unit can be made integral with the column by casting the combined column and power and video unit as one piece. In another embodiment, the power and video unit can be made integral with any of the other components of the multi-screen display system.

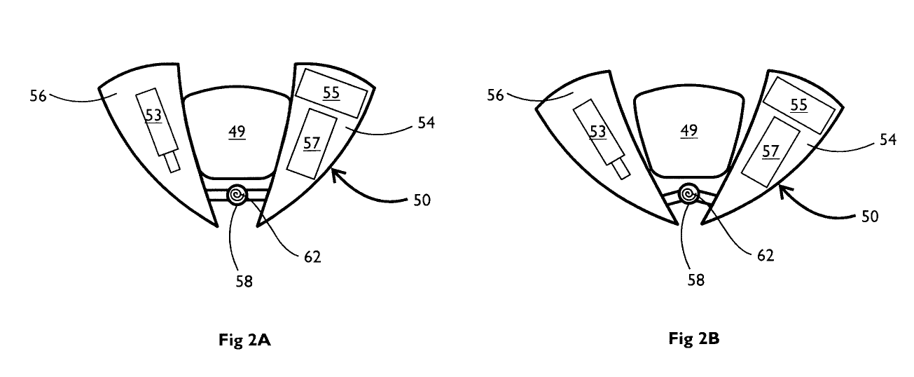

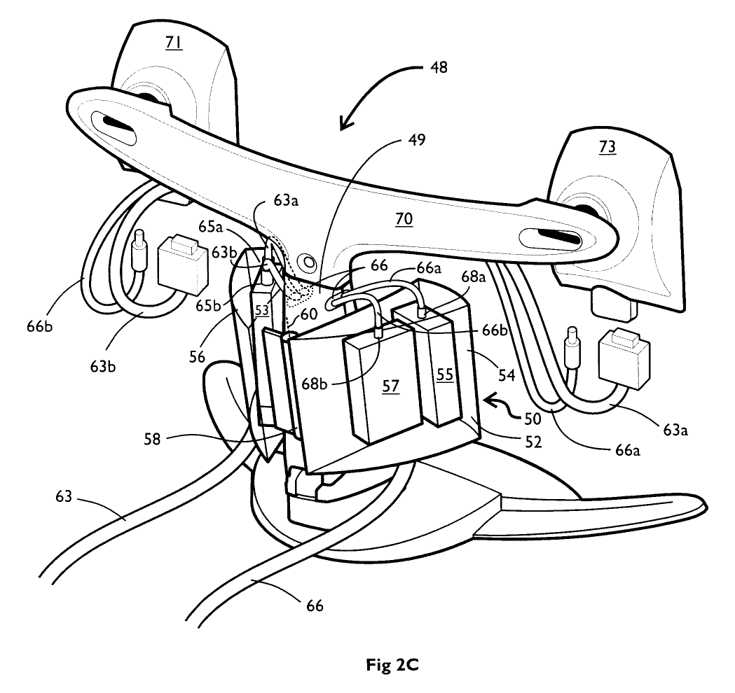

Referring to FIGS. 2A-C, a different embodiment of a power and video unit 50 is shown that mounts to the column 49 of a multi-screen display system 48. The power and video unit 50 includes a housing 52. The housing 52 includes a splitting device 53 and power modules 55, 57 which are similar to those described above. The housing 52 can be constructed from two segments 54 and 56 joined together by a hinge 58. The hinge 58 can include a biasing mechanism 62, such as a torsional spring, that causes the two segments 54, 56 to clamp around the column 49. The two segments 54 and 56 can be adapted to rotate partially about a longitudinal axis 60 of the hinge 58 under torsional spring tension.

FIG. 2A shows a cross sectional view of the two segments 54 and 56 in a closed, clamped position around the column 49. FIG. 2B shows a cross sectional view of the two segments 54 and 56 rotated apart, in an open position, to remove the unit 50 from the column 49. (The cross-sectional planes shown in FIGS. 2A and B are parallel to the working surface on which the multi-screen display system rests.) Thus, with this spring action, the unit 50 can be made portable, being removed from one column and mounted to another column as need be.

FIG. 2C shows a rear view of the unit 50 mounted to the column 49 of the multi-screen display system 48. A video cable 63 delivers video signals from a computer tower or notebook (not shown) to the segment 56 containing the splitting device 53. Video cables 63a and 63b are removably coupled to the splitting device 53 via accessible video output ports 65a and 65b. These cables 63a and 63b enter the column 49 via an aperture 66. The cables 63a and 63b run up the column 49 and across both sides of an arm 70 of the multi-screen display system 48. Likewise, a power cable 66 delivers power from a power source to the segment 54 containing the power modules 55 and 57. Power cables 66a and 66b are removably coupled to the power modules 55 and 57 via accessible ports 68a and 68b. These cables 66a and 66b enter the column through an aperture 66, run up the column 49 and across both sides of the arm 70. The cables 63a, 63b, 66a and 66b exit the arm 70 and couple to the monitors via the connectors 71 and 73.

Advantageously, the power and video units 10 or 50 described herein convert a single video signal, from a computer, such as a notebook or desktop computer, into a plurality of signals suitable for multi-screen viewing, while providing efficient cable management. More generally, the units 10 or 50 convert M video signals to N>M video signals suitable for an N-screen display system.

As mentioned above, the power and video unit, or a portion thereof, can also be formed integrally with the column of the multi-screen display system, using any suitable process, such as by injection molding. Moreover, instead of the column, in other embodiments, the power and video unit can be disposed in any other part of the multi-screen display system, such as the base or arm. The power and video unit may also be separate from the multi-screen display system, albeit with power and/or video cable connections to the notebook or desktop computer and the multi-screen display system.

Although FIGS. 1A-B and 2A-C show embodiments especially suited for a two-screen display system, it should be understood that the principles of the present invention include a power and video unit suitable for an N-screen display system, where N is any integer greater than one. In this general case, the power and video unit would include N power modules, and N power and video output ports.

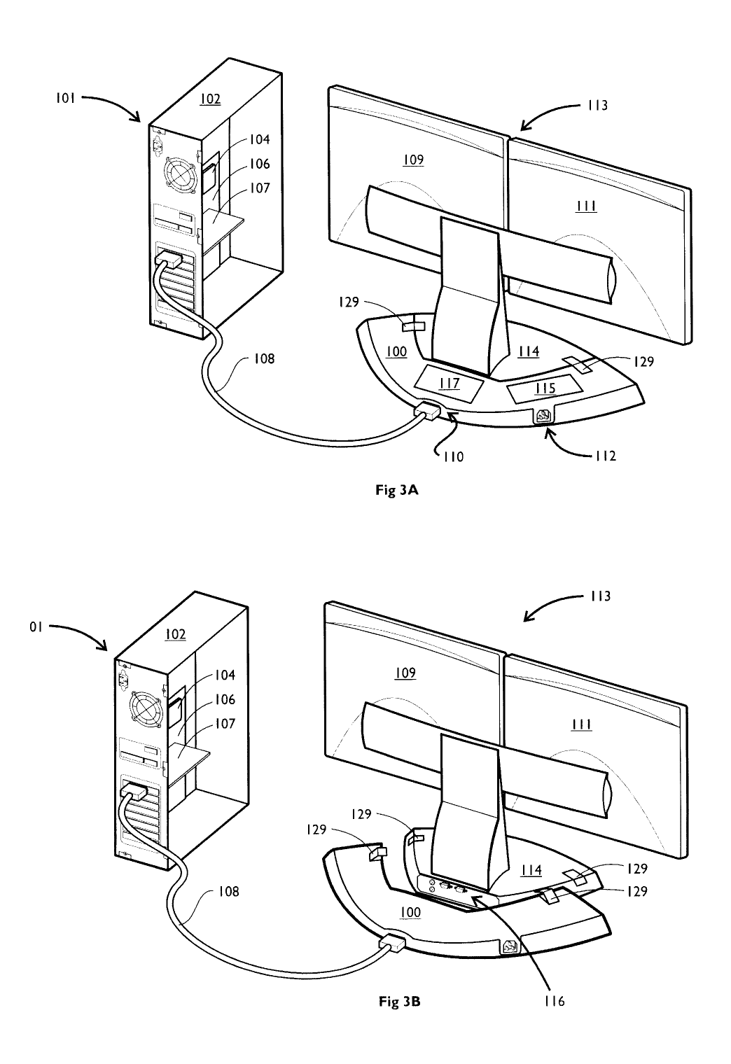

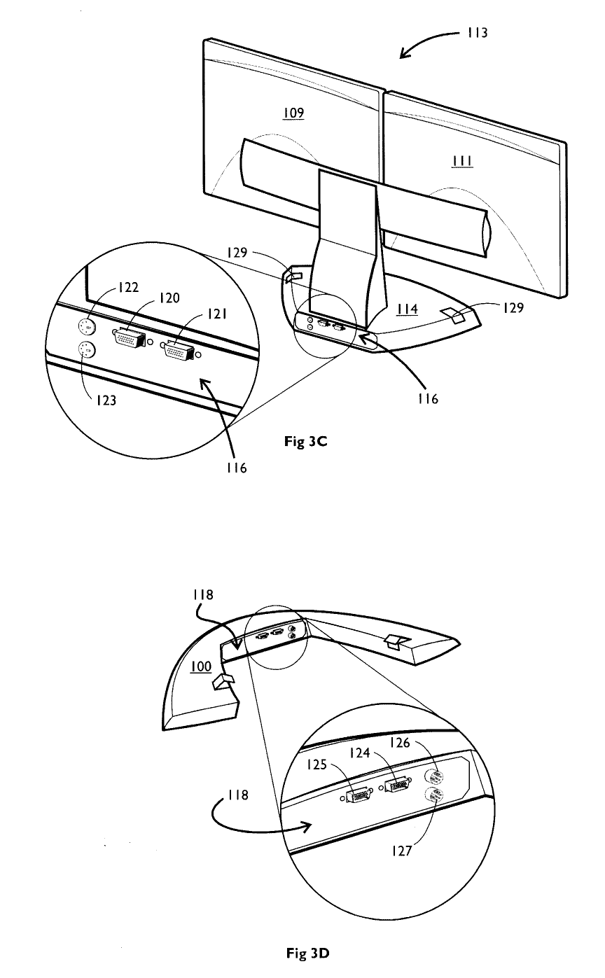

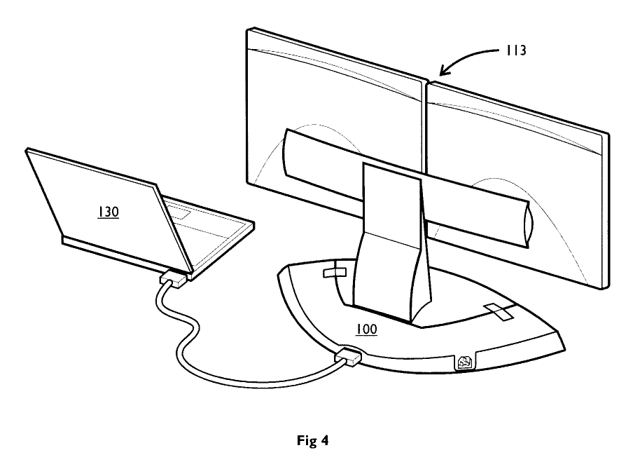

FIGS. 3A and 3B show a base mounted power and video unit 100. The base mounted power and video unit 100 is connected to a computer 101 having a computer tower 102 containing a central processor 104 on a motherboard 106. The computer tower 102 also includes a graphics card 107. The base mounted power and video unit 100 is connected to the computer tower 102 via a video cable 108 for transmitting video data to screens 109 and 111 of a multi-screen display system 113. A video port 110 on the base mounted power and video unit 100 allows the video cable 108 to be connected thereto. In addition, the base mounted power and video unit 100 has a power port 112 for connecting a power supply cable (not shown). It should be understood that in another embodiment, the power cable and the video cable could be amalgamated so that one port of the base mounted power and video unit 100 can receive both video data and power.

The base mounted power and video unit 100 is mounted to a base 114 of the multi-screen display system 113. In FIG. 3A, the base mounted power and video unit 100 is shown connected to the base 114. In FIG. 3B, the base mounted power and video unit 100 is shown unconnected to the base 114. The base 114 includes a base port deck 116 containing several ports. FIG. 3C includes an exploded view of the base port deck 116 showing two VGA ports 120 and 121 (one for each screen 109 and 111) for transmitting video data, and power ports 122 and 123 (one for each screen 109 and 111) for transmitting power.

Referring to FIG. 3D, the base mounted power and video unit 100 includes a unit connector deck 118 containing connectors 124-127 that mate with the ports 120-123 of the base port deck 116. In particular, VGA connectors 124 and 125 mate with VGA ports 120 and 121, and power connectors 126 and 127 mate with power ports 122 and 123. Other types of video connectors and ports, such as DVI, HDMI and DisplayPort™ can also be used.

The base mounted power and video unit 100 includes a power assembly 115 for providing power to the two screens 109 and 111 via the power connectors and ports 122, 123, 126, 127. The base mounted power and video unit 100 also includes a splitting device 117 that accepts a single video input signal, via the input video port 110, from the computer 101. The splitting device 117 processes the video input signal and outputs a plurality of output signals via the output video connectors and ports 120, 121, 124, 125. In addition to powering the monitors 109 and 111, power received at the port 112 can also be used to power the splitting device 117.

Aside from providing the necessary video data and power connections, the connectors and ports on the decks 116 and 118 provide a physical connection that secures the base mounted power and video unit 100 to the base 114. In addition, other mechanical fasteners 129 can be used to secure the base mounted power and video unit 100 to the base 114. These fasteners can include Velcro™, latches, and screws. Preferably, the fasteners 129 allow the base mounted power and video unit 100 to be easily disconnected from the base 114 to make the base mounted power and video unit 100 portable. In such manner, the unit 100 can be removed from one multi-screen display system and connected to another. It should be understood that although the ports 120, 121, 122 and 123 shown on the base 114 have female mating parts, and the connectors 124, 125, 126 and 127 shown on the base mounted power and video unit 100 have male mating parts, these can be reversed. In other words, the base mounted power and video unit can have the female mating parts and the base can have the male mating parts, or some combination thereof.

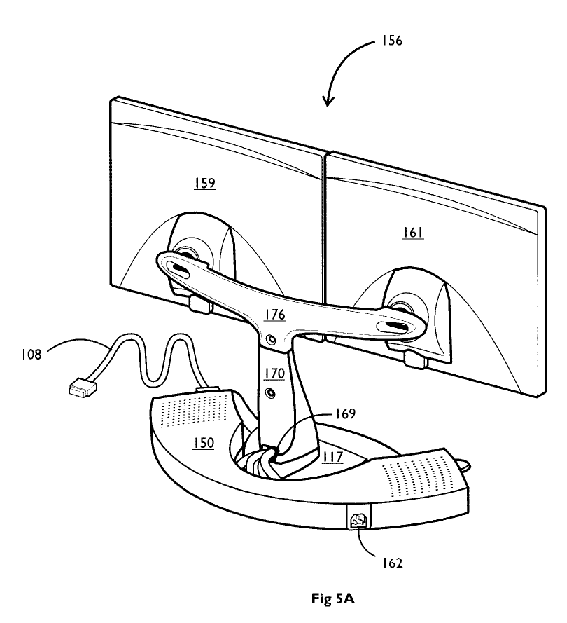

FIG. 4 shows the same base mounted power and video unit 100 shown in FIGS. 3A-3D, but in an embodiment where the base mounted power and video unit 100 is connected to a notebook computer 130.

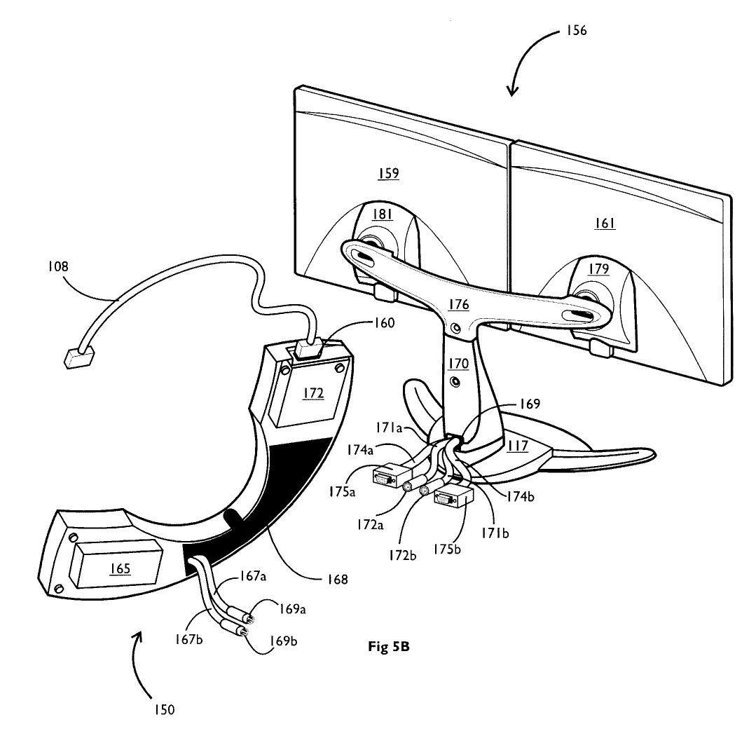

FIGS. 5A and 5B show yet another embodiment of a power and video unit 150, consistent with the principles of the present invention. The power and video unit 150 is connected to a computer tower (not shown) containing a central processor, and a graphics card. The power and video unit 150 is connected to the computer tower via a video cable 108 for transmitting video data to screens 159 and 161 of a multi-screen display system 156. An input video port 160 on the power and video unit 150 allows the video cable 108 to be connected thereto. In addition, the power and video unit 150 has a power port 162 for connecting to a power supply cable (not shown). It should be understood that in another embodiment, the power cable and the video cable can be amalgamated so that one port of the base mounted power and video unit 150 can receive both video data and power, as in the embodiment shown in FIG. 1B.

The power and video unit 150 includes a power assembly 165 for providing power to the two screens 159 and 161. Power is delivered to the screens 159 and 161 via power cables 167a and 167b coupled to the power assembly 165. The power cables 167a and 167b terminate at respective power connectors 169a and 169b. Additional power cables 171a and 171b have power connectors 172a and 172b that mate with the power connectors 169a and 169b. The power cables 171a and 171b enter the multi-screen display system 156 through an opening 169 in the column 170 thereof. The mated connectors 169a, 169b, 172a and 172b can be disposed in a recess 168 at the bottom of the power and video unit 150 to reduce clutter. This recess 168 is shown in FIG. 5B.

The power and video unit 150 also includes a splitting device 172 that accepts a single video input signal, via the input video port 160, from a computer. The splitting device 172 processes the video input signal and outputs a plurality of (in this case two) output signals. Video signals are delivered to the screens 159 and 161 via output video cables 174a and 174b having connectors 175a and 175b that couple to ports (not shown) on the splitting device 172 that can be accessed via the recess 168. In FIG. 5B, the connectors 175a and 175b are shown unconnected to the splitting device 175. The video cables 174a and 174b enter the multi-screen display system 156 through the opening 169.

The cables 171a, 171b, 174a and 174b enter the opening 169, travel up the column 170, along an arm 176 of the multi-screen display system 156 and out to monitor connectors 179 and 181 that connect to the monitors 159 and 161 to provide power and video signals thereto.

The power and video unit 150 is shaped to allow it to nest against a base 177, as shown in FIG. 5A. Optionally, the power and video unit 150 can be affixed to the base with appropriate fasteners, but not doing so allows the freedom to move the unit 150 to other locations in the vicinity of the multi-screen display system 156 without having to unfasten anything. To transport the unit 150 a greater distance, such as from one multi-screen device to another, would require the connectors 175a and 175b to be unconnected from the splitting device 172, and the connectors 169a and 169b to be unconnected from the complementary connectors 172a and 172b.

Advantageously, the power and video unit reduces cable clutter by requiring just two input cables (i.e., video cable 108 and a power cable, which is not shown in FIGS. 5A and 5B, that connects to the power port 162). In a different embodiment, a single power and video cable can be integrated, such as the cable 36 of FIG. 1B, further reducing the number of input cables to just one. Cables 171a, 171b, 174a and 174b are barely noticeable when the unit 150 nests against the base 177 (cf. FIG. 5A). If desired, they can be removed from view by placing an appropriate cover (not shown) between the power and video unit 150 and the column 170 that hides these cables.

The power and video unit 150 also allows a computer system to be easily upgraded from a system having just one video output feeding one screen to a system capable of producing a plurality of video outputs to feed a plurality of screens. In the example shown, the splitting device 172 takes one video input at the port 160 and converts the single video signal into two video signals to feed the two monitors 159 and 161.

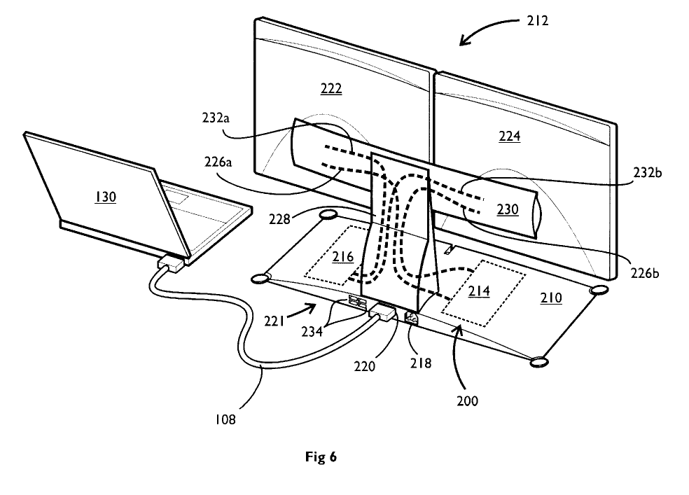

FIG. 6 shows another embodiment of a power and video unit 200 integrated into a base 210 of a multi-screen display system 212, in accordance with the principles of the present invention. The power and video unit 200 is included in the base 210 of the multi-screen display system 212. The power and video unit 200 includes a power assembly 214 and a splitting device 216, similar to ones described above. A power port 218 and a video port 220 reside at the back 221 of the base 210. The power port 218 is coupled to a power source (not shown) for providing power to two monitors 222 and 224 of the multi-screen display system 212. Likewise, the video port 220 is coupled to the notebook computer 130 via the video cable 108 to provide video signals to the two monitors 222 and 224.

The power assembly 214 receives power from the power port 218 and supplies power to the splitting device 216. The power assembly 214 also provides power to the monitors 222 and 224 via power cables 226a and 226b that run up a column 228 and across an arm 230 of the multi-screen display system 212.

The splitting device 216 receives video signals from the video port 220 and provides video signals to the monitors 222 and 224 via video cables 232a and 232b that run up the column 228 and across the arm 230 of the multi-screen display system 212.

Optionally, the back 221 of the base 210 can have other types of peripheral ports 234, such as USB ports, to input or output electronic signals. Such ports 234 can be in electronic communication with the notebook computer 130 and can be used for running peripheral devices, such as a keyboard, a mouse and a printer.

The embodiments provided above are meant to be exemplary only. Other variants fall within the scope of the invention. For example, it should be understood that the power and video unit could be mounted to, on or in the base and column. In other embodiments, the power and video unit can be mounted to, on or in on other parts of the multi-screen display unit, such as the arm supporting the screens, or the screens. In addition, the power and video unit can be a stand-alone unit, which, although in electronic communication with the multi-screen display systems via power and/or video cords, would otherwise be separate from the multi-screen display system. Such a stand-alone unit could include a housing to house the power modules and the splitting device. The scope of the invention is to be limited only by the following claims.

What is claimed is:

1. A power and video unit for a display system having N>1 screens, the power and video unit comprising:
an image splitting device that takes as input M video signals from a computer and outputs N>M video signals, one for each of the N screens; and
a power assembly for supplying power to each of the N screens.

2. The power and video unit of claim 1, wherein the display system further includes an arm for supporting the N screens, a base and a column connecting the base to the arm, and wherein the power and video unit is mounted to, in or on at least one of the base, the column, the arm and the N screens.

3. The power and video unit of claim 1, wherein the M input video signals are one of DVI and VGA signals.

4. The power and video unit of claim 1, wherein the N output video signals are one of DVI and VGA signals.

5. The power and video unit of claim 1, further comprising a housing containing the splitting device and the power assembly, the housing having a first segment and a second segment connected together by a hinge mechanism, wherein the first segment and the second segment can be rotated at the hinge to enable the housing to removably clamp onto the column.

6. The power and video unit of claim 1, further comprising
a unit connector deck having connectors that mate with ports on the base for transmitting at least one of power and video signals to the monitors.

7. The power and video unit of claim 6, wherein the connectors include
VGA connectors that mate with VGA ports on the base; and
power connectors that mate with power ports on the base.

8. The power and video unit of claim 6, wherein the connectors include
DVI connectors mate with DVI ports on the base; and
power connectors that mate with power ports on the base.

9. The power and video unit of claim 1, further comprising a housing that houses the power assembly and the splitting device, and shaped to permit nesting with the base.
